(19) United States
(12) Patent Application Publication
(10) Pub. No.: US 2015/0115628 A1
(43) Pub. Date: Apr. 30, 2015

(54) LOCK COMPONENT

(71) Applicant: Brose Schliesssysteme GmbH & Co. KG, Wuppertal (DE)

(72) Inventors: Michael Wittelsbuerger, Lake Orion, MI (US); David Rosales, Rochester Hills, MI (US)

(21) Appl. No.: 14/065,124

(22) Filed: Oct. 28, 2013

(51) Int. Cl. E05B 85/00

(52) U.S. Cl. CPC E05B 85/00
USPC 292/200; 29/434

(57) ABSTRACT

A lock component of a motor vehicle lock arrangement with a mechanical actuation chain for the transmission of actuation movements, the actuation chain can comprise at least one actuation lever, which is pivotable around an actuation lever axis. A compensation mechanism can be provided, by which the actuation lever axis may be displaced relative to a reference position at least once for mechanical tolerance compensation such that the actuation chain may transmit actuation movements with the actuation lever axis being displaced accordingly.

### FIELD OF THE INVENTION

The invention is directed to a lock component of a motor vehicle lock arrangement and to a method for the assembly of such a lock component.

### BACKGROUND

The motor vehicle lock arrangement in question is assigned to a motor vehicle door arrangement which comprises at least a motor vehicle door. The expression “motor vehicle door” is to be understood in a broad sense. It includes in particular side doors, back doors, lift gates, trunk lids or engine hoods. Such a motor vehicle door may generally be designed as a sliding door as well.

The motor vehicle lock arrangement generally comprises at least a motor vehicle lock that holds the motor vehicle door in its closed position and that allows to open the motor vehicle door depending on the current lock status.

Usually, the motor vehicle lock arrangement also includes an inner door handle and an outer door handle, which are coupled to the motor vehicle lock for actuation.

The motor vehicle lock arrangement may also comprise a closing aid module that provides a motorized adjustment of the motor vehicle door from a preliminary closed position into the main closed position.

The lock component in question may be, for example, any one of the above noted components of the motor vehicle lock arrangement. The known lock component (DE 103 37 392 A1), which is the starting point for the present invention, is provided with the usual lock elements catch and pawl, wherein the pawl may be deflected into a release position by actuation of an actuation lever. Accordingly, the known lock component is a motor vehicle lock which is normally situated in a motor vehicle door.

In order to deflect the pawl out of engagement from the catch the known motor vehicle lock comprises a mechanical actuation chain for the transmission of actuation movements, which actuation chain comprises an outer actuation lever, which is pivotable around a stationary actuation lever axis.

One cost factor for the known motor vehicle lock is generally the occurrence of mechanical tolerances. Those mechanical tolerances go back largely on manufacturing tolerances in housing components, gearing components, bearing components etc. The result of such mechanical tolerances is the fact that in the non actuated state of the actuation chain a play remains in the actuation chain which is hardly predictable. In the known motor vehicle lock the geometry of the components of the actuation chain may be modified for the compensation of mechanical tolerances.

One disadvantage of the known solution is the high structural complexity which leads to a reduction in mechanical robustness. Another disadvantage is the low compactness due to additional constructional components necessary.

It is the object of the invention to improve the known lock component of a motor vehicle lock arrangement such that a cost effective mechanical tolerance compensation is possible with high mechanical robustness and at the same time high compactness.

### SUMMARY

The above noted object is solved for a lock component of a motor vehicle lock.

The basic idea underlying the invention is to provide a compensation mechanism for mechanical tolerance compensation by which the position of the actuation lever axis of at least one actuation lever may be adjusted. It has been found that for the adjustment of the position of the actuation lever axis a number of compact and at the same time mechanically robust solutions are possible.

The adjustment may be provided as an automatic adjustment, that may, for example, be spring driven. In an embodiment, the adjustment is taking place only once, such as during the assembly of the proposed lock component.

An embodiment is directed to a compensation mechanism with a compensation element, which is compensation eccentric. A pivoting adjustment of the compensation eccentric leads to a position change of the actuation lever axis. This position change allows in the end the desired tolerance compensation.

Some embodiments are directed to fixing the compensation mechanism in the respective compensation state. Some embodiments provide a snap mechanism for easy adjustment of the compensation element, which adjustment may be fixed by the fixing element.

The proposed solution for mechanical tolerance compensation is applicable for almost any lock component of a motor vehicle lock arrangement.

According to some embodiments, the lock component is a motor vehicle lock. In an embodiment the mechanical actuation chain serves the manual and/or motorized deflection of the pawl into its release position. In another an embodiment the actuation chain serves the adjustment of the catch from a preliminary lock position into a main lock position as a closing aid.

The proposed lock component may also be a component that is arranged separately from the motor vehicle lock, namely as a closing aid module for example. An effective mechanical compensation mechanism is essential for the reproducibility of operation for those modules as well.

Another embodiment is directed to a method for the assembly of a lock component as proposed above.

The idea underlying the second teaching is to perform mechanical tolerance compensation with the proposed compensation mechanism during the assembly of the proposed lock component. In further detail it is proposed that the sides of the play in the actuation chain, which can remain in the non actuated state of the actuation chain, may be adjusted via the compensation mechanism.

Performing the above noted mechanical tolerance compensation during assembly of the proposed lock components ensures the compensation of all tolerances that go back on the manufacturing processes described in the general part of the specification. With this it is possible to apply manufacturing processes with high mechanical tolerances that are particularly cost effective.

One embodiment provides a lock component of a motor vehicle lock arrangement with a mechanical actuation chain for the transmission of actuation movements, wherein the actuation chain comprises at least one actuation lever, which is pivotable around an actuation lever axis, wherein a compensation mechanism is provided, by which the actuation lever axis may be displaced relative to a reference position at least once for mechanical tolerance compensation such that the actuation chain may transmit actuation movements with the actuation lever axis being displaced accordingly.

In an embodiment, in the non-actuated state of the actuation chain, a play remains in the actuation chain, which size is adjustable by the adjustability of the position of the actuation lever axis.

In an embodiment, the compensation mechanism comprises a compensation element, by which adjustment the position of the actuation lever axis may be adjusted.

In an embodiment, the compensation element is a compensation eccentric, which is pivotable around a compensation axis, and that the actuation lever is hinged to the compensation eccentric with its actuation lever axis arranged eccentrically with respect to the compensation axis.

In an embodiment, the compensation mechanism comprises a fixing mechanism, with which the compensation element is fixable in its present position.

In an embodiment, the fixing mechanism comprises a fixing element, which may be brought into a fixing position, in which it fixes, in particular blocks, the compensation element in its present position.

In an embodiment, the fixing mechanism provides a snap mechanism with a snap element, such that the compensation element may be brought into different, mechanically stable positions in a snapping manner.

In an embodiment, the compensation element may be blocked in its present position by the fixing element entering into a blocking engagement with the snap element.

In an embodiment, the lock component is a motor vehicle lock with a catch and a pawl, which is assigned to the catch, wherein the catch can be brought into an opening position and into a closed position, wherein the catch, which is in the closed position, is or may be brought into holding engagement with a lock striker, wherein the pawl may be brought into an engagement position, in which it is in blocking engagement with the catch, wherein the pawl may be deflected into a release position, in which it releases the catch.

In an embodiment, the actuation chain serves for manual and/or motorized deflection of the pawl into its release position.

In an embodiment, for deflecting the pawl, the actuation lever or a deflection lever downstream the actuation lever towards the pawl is engageable with the pawl or a pawl lever, which is coupled to the pawl.

In an embodiment, the actuation chain serves for adjustment of the catch from a preliminary lock position into a main lock position as a closing aid.

In an embodiment, the lock component is a closing aid module for the motor vehicle lock and that the actuation chain serves for adjustment of the catch from a preliminary lock position into a main lock position as a closing aid.

In an embodiment, the lock component is a closing aid module for the motor vehicle lock and that the actuation chain serves for adjustment of the lock striker from a preliminary lock position into a main lock position as a closing aid.

In an embodiment, in a pre-assembled state, in the mechanical actuation chain of the motor vehicle lock, a play remains in the mechanical actuation chain, which size is being adjusted during assembly by adjusting the position of the actuation lever axis via the compensation mechanism.

In an embodiment, the position of the actuation lever axis is adjustable by the compensation mechanism in a direction lateral to the actuation lever axis.

In an embodiment, the compensation eccentric provides a bearing journal for a bearing bore of the actuation lever, or, that the compensation eccentric provides a bearing bore for a bearing journal of the actuation lever.

In an embodiment, the fixing element is designed as a fixing pin, which may be brought into fixing engagement with a counter element.

In an embodiment, the fixing element is designed as a fixing pin, which may be brought into blocking engagement with a counter element.

In an embodiment, the actuation lever is coupled to an outer actuation lever and/or an inner actuation lever.

In an embodiment, the deflection lever is hinged to the actuation lever eccentrically with respect to the actuation lever axis and that the deflection lever is or may be coupled to the pawl or a pawl actuation lever, which is coupled to the pawl.

In an embodiment, the deflection lever is part of a coupling arrangement between the actuation lever and the pawl.

In an embodiment, the mechanical actuation chain of the motor vehicle lock is in the non-actuated state of the actuation chain.

### BRIEF DESCRIPTION OF THE FIGURES

In the following, the invention will be described in an example referring to the drawings. In the drawings there is shown in

FIG. 1 the relevant parts of a proposed lock component in a first state of compensation,

FIG. 2 the proposed lock component of FIG. 1 in a second compensation state and

FIG. 3 the relevant parts of the compensation mechanism of the proposed lock component.

### DETAILED DESCRIPTION

The lock component 1 shown in the drawings is signed to a motor vehicle lock arrangement 2. Such motor vehicle lock arrangement 2 may comprise a motor vehicle lock, an outer door handle, an inner door handle, an opening aid module etc. In the following the proposed lock component 1 is described with reference to the drawings, which show a lock component 1 which is being designed as a motor vehicle lock. All explanations given for the motor vehicle lock are applicable to all the other lock components that may be subject to the teaching of the present patent application.

The motor vehicle lock arrangement is assigned to a motor vehicle door arrangement which comprises at least a motor vehicle door not shown in the drawings. The expression “motor vehicle door” is to be understood in a broad sense as has been explained in the introductory part of the specification.

The motor vehicle lock 1 comprises a mechanical actuation chain 3 for the transmission of actuation movements. The actuation chain 3 comprises at least one actuation lever 4, which is pivotable around an actuation lever axis 4a.

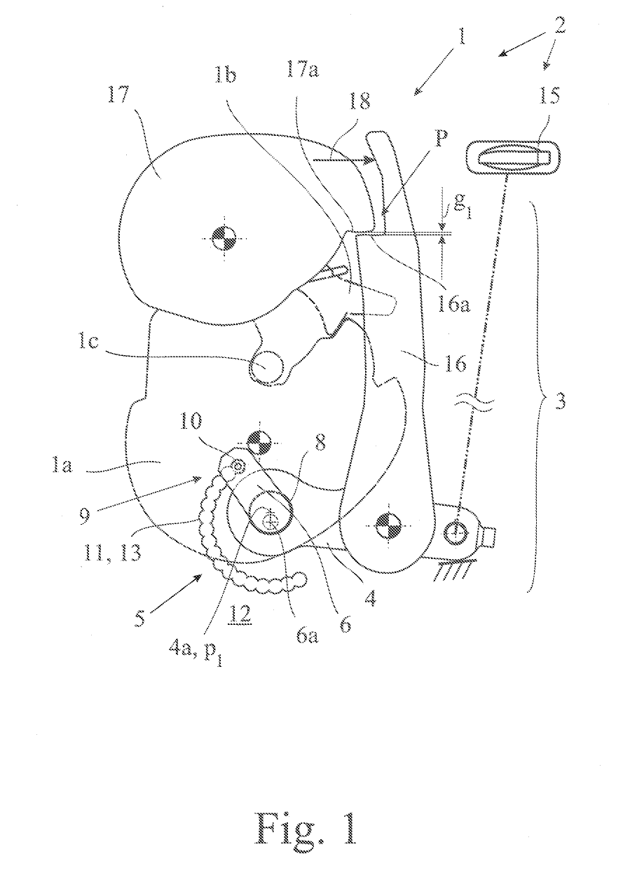

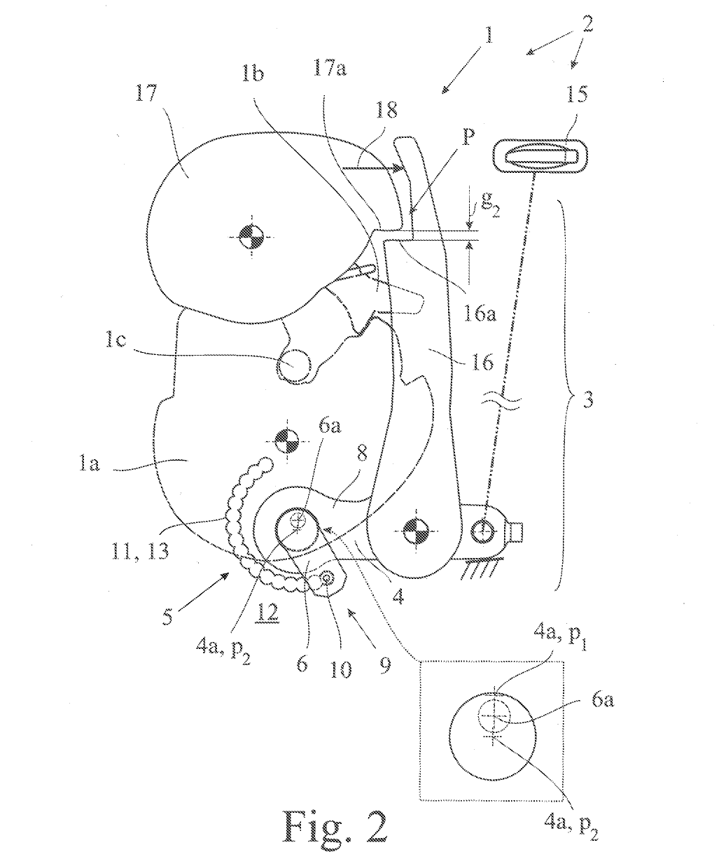

A comparison of FIGS. 1 and 2 shows that in the mechanical actuation chain 3 of the motor vehicle lock 1a play P is provided, which size g₁ is smaller in FIG. 1 than its size g₂ in FIG. 2. The above noted change of the size of the play P goes back on a compensation mechanism 5, by which the position of the actuation lever axis 4a may be adjusted relative to a reference position at least once for mechanical tolerance compensation, such that the actuation chain 3 may transmit actuation movements with the actuation lever 4a displaced accordingly.

It may well be taken from FIGS. 1 and 2 that the position p₁ of the actuation lever axis 4a shown in FIG. 1 and the position p₂ of the actuation lever axis 4a shown in FIG. 2 are different such that the size g₁ of the play P shown in FIG. 1 is smaller than the size g₂ of the play P shown in FIG. 2. For clarification both positions p₁,p₂ are indicated in the detail in view of FIG. 2.

The reference position may be any position, relative to which all other positions of the actuation lever axis 4a may be defined. For example displayed in the drawings, the position p₁ may well be a reference position in this context. However, the reference position may also be any position at or within the lock component.

It may also be suitable that the adjustability of the position of the actuation lever axis 4a is provided only once by the compensation mechanism 5, in particular during the assembly of the motor vehicle lock arrangement. However, it may also be advantageous to be able to adjust the position of the actuation lever axis 4a during normal service. It is also a possibility that the compensation mechanism 5 adjusts the position of the actuation lever axis 4a automatically during normal operation. In the shown embodiment, however, the adjustability is only provided once by the compensation mechanism 5.

FIGS. 1 and 2 show the actuation chain 3 of the motor vehicle lock 1 in the non actuated state. As noted above, a play P remains in the actuation chain 3, which size g₁, g₂ is adjustable by the adjustability of the position of the actuation lever axis 4a. The play P is only shown in the drawings as an example. Obviously there may be play in other places within the mechanical actuation chain 3. The position of the actuation lever axis 4a is adjustable by the compensation mechanism 5 in a direction lateral to the actuation lever axis 4a.

In the shown embodiment the compensation mechanism 5 comprises a compensation element 6, by which adjustment the position of the actuation lever axis 4a may be adjusted. A number of advantageous variants for the realization of the compensation element 6 are possible.

The embodiment shown in the drawings is provided with a compensation element 6 which is designed as compensation eccentric. The compensation eccentric 6 is pivotable around a compensation axis 6a, wherein the actuation lever 4 is hinged to the compensation eccentric 6 with its actuation lever axis 4a arranged eccentrically with respect to the compensation axis 6a. With this simple construction it is possible to displace the actuation lever axis 4a simply by pivoting the compensation eccentric 6.

The above noted hinge of the actuation lever 4 to the compensation eccentric 6 is realized by the compensation eccentric 6 providing a bearing journal 7 for a bearing bore 8 of the actuation lever 4. Conversely it may be advantageous that the compensation eccentric provides a bearing bore for a bearing journal of the actuation lever 4.

In order to ensure that the compensation mechanism 5 stays in its position which has been set before the compensation mechanism 5 comprises a fixing mechanism 9, with which the compensation element 6, here the compensation eccentric 6, is fixable in its present position.

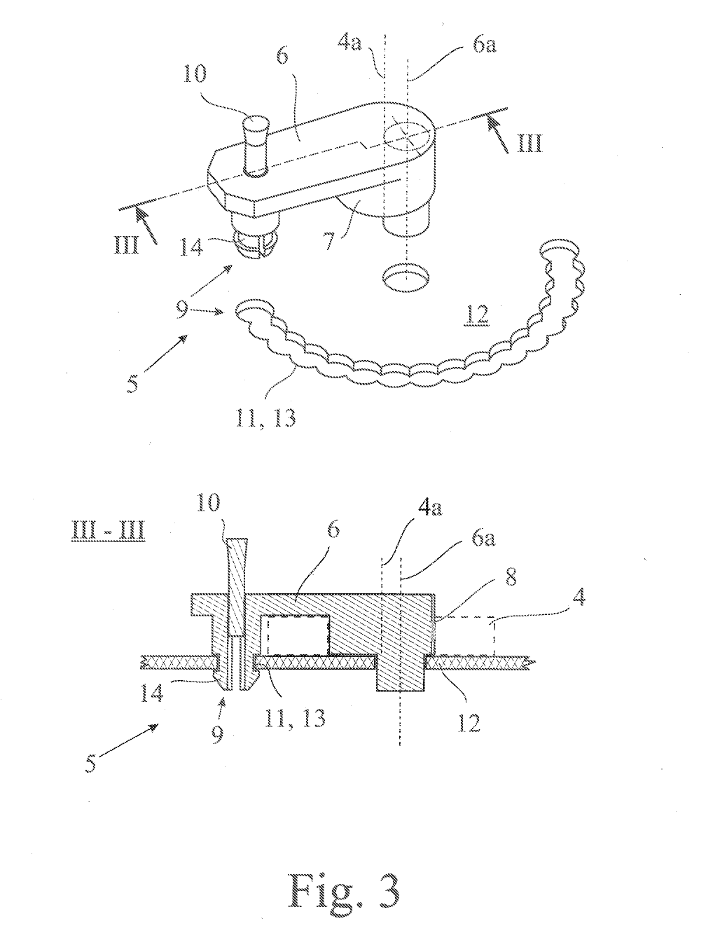

Here the fixing mechanism 9 comprises a fixing element 10, which may be brought into a fixing position (view III-III of FIG. 3), in which it fixes, in particular blocks, the compensation eccentric 6 in its present position. It may be seen from FIG. 3 that the fixing element 10 can be designed as a fixing pin, which may be brought into fixing, here locking, engagement with a counter element 11. FIG. 3 shows that a counter element 11 is a wall segment 12 that comprises a cutout 13.

The shown embodiment is particularly user friendly as the fixing mechanism 9 provides a snap mechanism with a snap element 14, such that the compensation element 6, here the compensation eccentric 6, may be brought into different, mechanically stable positions in a snapping manner. In the shown embodiment the snap element 14 is designed in the art of a dowel that may be snap-fitted into the cutout 13. Accordingly the compensation eccentric 6 may be pivoted around the compensation axis 6a snapping from one pivot position to the next pivot position.

Interesting is now the fact that the compensation element 6, here the compensation eccentric 6, may be blocked in its present position by the fixing element 10 into a blocking engagement with the snap element 14. In further detail the fixing element 10 may be driven into the dowel like snap element 14 such that the compensation element 6, here the compensation eccentric 6, is blocked in its present position as shown in dotted lines in view III-III of FIG. 3.

It has been noted already that the proposed lock component 1 can be a motor vehicle lock as shown in the drawings. This motor vehicle lock 1 comprises the usual locking elements catch 1a and pawl 1b, which pawl 1b is assigned to the catch 1a. The catch 1a can be brought into an open position (not shown) and into a closed position shown in the drawings. In the closed position the catch 1a is or may be brought into holding engagement with a lock striker 1c, which is shown in the drawings as well. The motor vehicle lock 1 is normally arranged at or in the motor vehicle door, but the lock striker 1c is usually arranged at the motor vehicle body.

The pawl 1b may be brought into an engagement position, shown in FIG. 1, in which it is in blocking engagement with the catch 1a. In the depicted embodiment, the pawl 1b blocks the catch 1a in its closed position in a mechanically stable manner such that the pawl 1b itself does not have to be blocked. For release of the catch 1a into its open position, the pawl 1b may be deflected into a release position, which goes back on a deflection of the pawl 1b in the anti-clockwise direction starting from FIG. 1. The deflected pawl 1b releases the catch 1a such that the catch 1a may pivot into the direction of its opening position which is the anti-clockwise direction starting from FIG. 1.

The actuation lever 4 is provided for deflecting the pawl 1b into the release position. This deflection may take place based on manual and/or motorized actuation.

Here the actuation lever 4 may be coupled to a door handle 15, and to an outer door handle 15, such that the assigned motor vehicle door may be opened by actuating the door handle 15, thereby actuating also the actuation lever 4. The apparatus for coupling the outer door handle 15 to the actuation lever 4 is a bowden cable.

Depending on the application the actuation lever 4 may be coupled to an inner actuation lever as well. Such an inner actuation lever is not shown in the drawings.

FIGS. 1 and 2 show that for deflecting the pawl 1b, a deflection lever 16 downstream the actuation lever 4 towards the pawl 1b is engageable with the pawl 1b, or as is realized in the shown embodiment, with a pawl lever 17. It may be also advantageous that the actuation lever 4 itself is engageable with the pawl 1b or a pawl lever 17. In any case, the pawl lever 17 is coupled to the pawl 1b such that pivoting the pawl lever 17 in the anti-clockwise direction starting from FIG. 1 leads to a corresponding pivot motion of the pawl 1b in the anti-clockwise direction.

It is apparent from FIGS. 1 and 2 that the deflection lever 16 is hinged to the actuation lever 4 eccentrically with respect to the actuation lever axis 4a and that, as noted above, the deflection lever 16 is or may be coupled to the pawl 1b or, as shown, to the pawl lever 17, which is coupled to the pawl 1b.

The deflection lever 16 is part of a coupling arrangement between the actuation lever 4 and the pawl 1b which leads to a compact overall structure. By moving the deflection lever 16 in the clockwise direction starting from FIG. 1 the deflection lever 16 may be brought out of engagement from the pawl lever 17. For this, a decoupling actuation 18 has to be introduced into the deflection lever 16, which decoupling actuation is denominated with reference number 18. The deflection lever 16 may also be part of a crash safety mechanism. According to this mechanism, an inertial characteristic of the deflection lever 16 causes a deflection movement along a free-wheeling path, in which the free-wheeling path the deflection lever 16 misses the engagement with the pawl lever 17. This particular movement of the deflection lever 16 takes place, when the actuation movement surpasses a rapidity threshold that can only be caused by crash accelerations, which do not occur in normal operation. The motor vehicle lock that comprises such a crash mechanism is described in U.S. patent application Ser. No. 13/941,254 of Jul. 12, 2013, which goes back on the applicant of the present patent application and which is hereby included into the present patent application by reference.

As described above the actuation chain 3 of the proposed lock component 1 serves for deflecting the pawl 1b into its release position. However, the proposed actuation chain 3 may be applied to a number of different areas.

One application for the proposed actuation chain 3 would be the function of a closing aid, which adjusts the catch 1a from a preliminary lock position into the shown main lock position. Such adjustment of the catch 1a would be a pivot movement of the catch 1a in the clockwise direction into the position shown in FIG. 1. The function of the closing aid may be integrated into the motor vehicle lock 1. However, it may also be advantageous to realize the function of the closing aid in a closing aid module which is designed separately from the motor vehicle lock 1.

It may also be advantageous to realize the function of a closing aid by having the actuation chain 3 serve for adjustment of the lock striker 1c from a preliminary lock position into a main lock position, thereby pulling the assigned motor vehicle door into its fully closed position. Again the lock component can be a closing aid module which is realized separately from the motor vehicle lock 1.

According to another teaching a method for the assembly of a proposed lock component 1 is being claimed. It is of particular importance for the second teaching that in a pre-assembled state and in the non-actuated state of the actuation chain 3, a play remains in the actuation chain 3, which size is being adjusted during assembly by adjusting the position of the actuation lever axis 4a via the compensation mechanism 5 as explained above.

The above compensation during assembly may be performed with the help of a measuring apparatus to measure the size of the play P and at the same time to turn the compensation eccentric 6 until a predetermined play is reached. Due to the above noted snap element 14 this position of the compensation eccentric 6 is preliminarily fixed. Subsequently the fixing element 10 is driven into the snap element 14 such that the snap compensation eccentric 6 is finally blocked in its position.

With the compensation during assembly all tolerances that go back on the manufacturing process of housing components or the like may be compensated with almost no effort. Those manufacturing tolerances may accordingly be of considerable size without any functional disadvantage, which makes the manufacturing process particularly cost effective.

1. A lock component of a motor vehicle lock arrangement with a mechanical actuation chain for the transmission of actuation movements, wherein the actuation chain comprises at least one actuation lever, which is pivotable around an actuation lever axis,
wherein
a compensation mechanism is provided, by which the actuation lever axis may be displaced relative to a reference position at least once for mechanical tolerance compensation such that the actuation chain may transmit actuation movements with the actuation lever axis being displaced accordingly.

2. The lock component according to claim 1, wherein in the non-actuated state of the actuation chain, a play remains in the actuation chain, which size is adjustable by the adjustability of the position of the actuation lever axis.

3. The lock component according to claim 1, wherein the compensation mechanism comprises a compensation element, by which adjustment the position of the actuation lever axis may be adjusted.

4. The lock component according to claim 1, wherein the compensation element is a compensation eccentric, which is pivotable around a compensation axis, and that the actuation lever is hinged to the compensation eccentric with its actuation lever axis arranged eccentrically with respect to the compensation axis.

5. The lock component according to claim 1, wherein the compensation mechanism comprises a fixing mechanism, with which the compensation element is fixable in its present position.

6. The lock component according to one claim 1, wherein the fixing mechanism comprises a fixing element, which may be brought into a fixing position, in which it fixes, in particular blocks, the compensation element in its present position.

7. The lock component according to claim 1, wherein the fixing mechanism provides a snap mechanism with a snap element, such that the compensation element may be brought into different, mechanically stable positions in a snapping manner.

8. The lock component according to claim 7, wherein the compensation element may be blocked in its present position by the fixing element entering into a blocking engagement with the snap element.

9. The lock component according to claim 1, wherein the lock component is a motor vehicle lock with a catch and a pawl, which is assigned to the catch, wherein the catch can be brought into an opening position and into a closed position, wherein the catch, which is in the closed position, is or may be brought into holding engagement with a lock striker, wherein the pawl may be brought into an engagement position, in which it is in blocking engagement with the catch, wherein the pawl may be deflected into a release position, in which it releases the catch.

10. The lock component according to claim 9, wherein the actuation chain serves for manual and/or motorized deflection of the pawl into its release position.

11. The lock component according to claim 9, wherein, for deflecting the pawl, the actuation lever or a deflection lever downstream the actuation lever towards the pawl is engageable with the pawl or a pawl lever, which is coupled to the pawl.

12. The lock component according to claim 9, wherein the actuation chain serves for adjustment of the catch from a preliminary lock position into a main lock position as a closing aid.

13. The lock component according to claim 9, wherein the lock component is a closing aid module for the motor vehicle lock and that the actuation chain serves for adjustment of the catch from a preliminary lock position into a main lock position as a closing aid.

14. The lock component according to claim 9, wherein the lock component is a closing aid module for the motor vehicle lock and that the actuation chain serves for adjustment of the lock striker from a preliminary lock position into a main lock position as a closing aid.

15. A method for the assembly of a lock component according to claim 1, wherein in a pre-assembled state, in the mechanical actuation chain of the motor vehicle lock, a play remains in the mechanical actuation chain, which size is being adjusted during assembly by adjusting the position of the actuation lever axis via the compensation mechanism.

16. The lock component according to claim 2, wherein the position of the actuation lever axis is adjustable by the compensation mechanism in a direction lateral to the actuation lever axis.

17. The lock component according to claim 4, wherein the compensation eccentric provides a bearing journal for a bearing bore of the actuation lever, or, that the compensation eccentric provides a bearing bore for a bearing journal of the actuation lever.

18. The lock component according to one claim 6, wherein the fixing element is designed as a fixing pin, which may be brought into fixing engagement with a counter element.

19. The lock component according to claim 11, wherein the deflection lever is hinged to the actuation lever eccentrically with respect to the actuation lever axis and that the deflection lever is or may be coupled to the pawl or a pawl actuation lever, which is coupled to the pawl.

20. A method for the assembly of a lock component according to claim 15, wherein the mechanical actuation chain of the motor vehicle lock is in the non-actuated state of the actuation chain.
